(19) United States
(12) Patent Application Publication
(10) Pub. No.: US 2018/0134103 A1
(43) Pub. Date: May 17, 2018

(54) Tire Provided With An Electronic Device

(71) Applicant: COMPAGNIE GENERALE DES ETABLISSEMENTS MICHELIN, Clermont-Ferrand (FR)

(72) Inventors: François-Xavier BRUNEAU, Clermont-Ferrand Cedex 9 (FR); Lionel FAGOT-REVURAT, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/564,256

(22) PCT Filed: Apr. 6, 2016
(86) PCT No.: PCT/EP2016/057461

§ 371 Date: Oct. 4, 2017

(30) Foreign Application Priority Data
Apr. 9, 2015 (FR) 1553041

(51) Int. Cl. B60C 23/04; B60C 11/03; B60C 19/00

(52) U.S. Cl. CPC B60C 23/0493; B60C 11/0304; B29D 2030/0077; B60C 2019/004; B60C 19/00

(57) ABSTRACT

Tire of maximum width LT comprising a tread (1) asymmetric about the equatorial plane, one of its sides of which is intended to be positioned on the outboard side of the vehicle, a crown inner liner, radially furthest on the inside of the crown, and an electronic device with a sensor making for measuring at least one parameter. This electronic device is installed in the tire under the crown, radially on the inside of the inner liner of the crown, on the side of the tread that is intended to be positioned on the outboard side of the vehicle with respect to the equatorial plane and such that the axial distance from the centre of gravity of the electronic device to the equatorial plane is at least equal to 5% and at most equal to 25% of the maximum axial width of the tire LT.

### FIELD OF THE INVENTION

The present invention relates to an asymmetric tire inside which an electronic device is installed, this being for any type of vehicle. The invention relates more particularly to passenger-vehicle tires.

A tire comprises a crown comprising a tread that is intended to come into contact with the ground via a tread surface, two beads that are intended to come into contact with a rim, and two sidewalls that connect the crown to the beads.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

What is meant by an asymmetric tire is tires such that a direction of mounting on the vehicle is predetermined by the manufacturer. They comprise an outer axial edge and an inner axial edge, the inner axial edge being the edge intended to be mounted on the bodyshell side of the vehicle when the tire is mounted on the vehicle in the said predetermined direction of mounting, and the outer edge being the opposite of that. In the document, the “vehicle outboard side” denotes the outer axial edge.

In general, the material that is radially innermost on all the parts of the tire, sidewalls, beads and crown, is designed to give the tire airtightness so as to maintain a constant pressure and also so as to preserve the other materials radially on the outside of it from the effects of the inflation gas, notably from oxygen. This radially innermost material, whatever its nature, is referred to as the inner liner.

### BACKGROUND

It is often advantageous to install within the tire, as described in documents US20110041309A1, US20110041977A1, US20110113630A1, and particularly on the inner liner, an electronic device which is either an electronic sensor, such as, in particular, a pressure, temperature sensor, an accelerometer or an identification system (RFID). The purpose of these electronic devices is to send information about the tire, its running parameters or an identification code, to receivers which may or may not be situated within the vehicle, on demand or continuously. The information received may be used, amongst other things, to inform the driver, for example of a variation in pressure, of the value of a temperature, to set the parameters of the vehicle in real-time, or to assist the professional in charge of tire maintenance or vehicle servicing management. Between the electronic device and the inner liner there is a material that allows the object to adhere to the tire, generally a polymer compound referred to as an interface compound.

These devices, as disclosed in document JP2011020557, have sometimes been installed on the bead, which is the most static region of the tire when running. However, the fitting and removal of a tire is such that the bead experiences deformation that make this installation difficult.

As far as the sidewalls are concerned, these are the regions that experience the greatest deformation during running and are therefore also the regions least favourable for accommodating this type of device.

In solutions in which the electronic device is placed under the crown, such as US2011/0041309 A1, it is positioned in the equatorial plane of the tire. This is because this position has the advantage of symmetry and makes it possible to get around the position in which the tire is mounted on the vehicle, but it does not make it possible to achieve the performance in terms of the ability to withstand speed desired by certain manufacturers of so-called sports vehicles. The problem is that, in order to improve the roadholding of these vehicles, they often have a high camber angle which results in asymmetry of the contact patch. These two characteristics have the effect that asymmetric tires are used on so-called sports vehicles. For asymmetric tires in this use, positioning the electronic device in the equatorial plane is not optimal either.

One of the difficulties with installing an electronic device in the tire on the sidewalls, the beads or on the equator under the crown is that its presence is prejudicial to the endurance of the tire, particularly at high speed, because of the loads and deformation it experiences.

### SUMMARY OF THE INVENTION

The main objective of the present invention is therefore to increase the high-speed endurance of an asymmetric tire comprising an electronic device.

This objective is achieved by a tire with a maximum axial width LT, intended to be mounted on a mounting rim, comprising:
two beads, intended to come into contact with the mounting rim, a crown comprising a tread intended to be in contact with the ground, two sidewalls connecting the crown to the beads,
the tread, asymmetric about the equatorial plane, delimiting two axial edges of the tread, one of which edges is intended to be positioned on the outboard side of a vehicle on which the mounting rim is fixed,
an inner liner of the crown which is radially furthest on the inside of the crown,
an electronic device; the electronic device being installed in the tire under the crown, radially on the inside of the inner liner of the crown, on the side of the axial edge of the tread that is intended to be positioned on the outboard side of the vehicle with respect to the equatorial plane.

The maximum axial width of the tire is measured at the sidewalls, the tire being mounted on its rim and lightly inflated, i.e. inflated to a pressure equal to 10% of the nominal pressure as recommended, for example, by the Tire and Rim Association or TRA.

The loads or deformation which are applied to the electronic device are great, whether this be during the mounting of the tire on the rim or during use. In particular, the centrifugal force exerted in the tire during running is such that the part best suited to the installation of such a device is the crown. In this case, the centrifugal force results in compression of the interface compound, deformation for which polymer materials have a high strength, and not a shear, for which deformation polymer materials have lower strength. For a positioning on the beads and the sidewalls, the centrifugal force has the effect that the shear loads on the interface compound are high, and prejudicial to its endurance, which may cause the electronic device to become detached.

By contrast, installing the electronic device in the equatorial plane is attractive only when the stress loads are symmetrical. Under cornering, the tires situated on the side of the instantaneous centre of rotation of the vehicle with respect to the centre of gravity of the vehicle are unloaded through the effect of centrifugal force and the stress load on these tires is not the maximum stress load that the tire has to withstand as therefore does the interface between the electronic device and the tire. By contrast, the tires situated on the opposite side from the instantaneous centre of rotation of the vehicle with respect to the centre of gravity of the vehicle, said to be on the outside of the bend, are subjected to a transfer of load which means that this situation is the most penalising condition in which the tire is used. Under the effect of this load, the contact patch experiences a deformation similar to a camber angle and such that the part of the tread situated on the equator experiences a non-zero circumferential load which balances with the circumferential load in the opposite direction situated on the part of the outer axial edge of the tread on the outboard side of the vehicle. Between these two zones, the equator and the axial edge on the outboard side of the vehicle, the tread zone is a zone in which the circumferential load is the lightest. This is therefore the most suitable zone in which to install an electronic device. When the tire experiences a high camber angle because of the configuration of the vehicle, this same zone is also the most suitable place in which to install an electronic device.

One of the preferred embodiments is for the electronic device to comprise at least one measurement sensor making it possible to measure at least one parameter of the tire. Specifically, electronic devices of particular interest for this type of tire and use are temperature or pressure sensors transmitting these parameters measured in the tire to the driver of the vehicle so as to alert him to inappropriate operation so that he can modify his driving style, for example his speed.

It is advantageous for the axial distance between the centre of gravity of the electronic device and the equatorial plane to be at least equal to 5% of the maximum axial width of the tire LT so as to avoid the zone most heavily loaded with motive axial loads, of the part of the tread that is positioned on the outboard side of the vehicle.

It is particularly advantageous for the axial distance between the centre of gravity of the electronic device and the equatorial plane to be at most equal to 25% of the maximum axial width of the tire LT so as to avoid the zone most heavily loaded with braking axial loads, of the part of the tread that is positioned on the outboard side of the vehicle.

In a preferred embodiment, the centre of gravity of the electronic device is situated radially in line with a circumferential groove in the tread. This embodiment makes it possible to reduce the temperature at the interface between the electronic device and the tire and thus improve the integrity of the interface compound. This is because, as a result of a reduction in the thicknesses of the polymer materials of the tire in line with a circumferential groove, the production of heat through the deformation of these materials is locally lower, and therefore the temperature is locally lower.

What is meant by a groove is any recessed region of the tread that is circumferential overall and overall makes a complete circuit of the tire, delimited by walls of material that face one another and are distant from one another by a non-zero distance, with a depth of at least 2 mm when the tire is new. These walls cannot come into contact with one another under normal running conditions. A circumferential groove has two walls of circumferential overall direction, one axially on the inside and the other axially on the outside.

What is meant by being positioned in line with the circumferential groove is that the centre of gravity of the electronic device is axially on the outside of the axially inside wall of the groove and axially on the inside of the axially outside wall of the groove, with a 5 mm tolerance on the axial positioning.

It is also advantageous for the centre of gravity of the electronic device to be situated radially in line with a rib of the tread. This is because, under heavy load, the initial deflections of the crown are located not under the ribs but under the grooves. These deflections generate significant deformation which could damage the interface compound forming the interface between the inner liner and the electronic device. In that case, positioning the electronic device in line with a rib improves the endurance of the interface compound and therefore of the tire.

What is meant by a rib is a raised element on a tread, this element extending in the circumferential direction and overall making a complete circuit of the tire, having a height of at least 2 mm when the tire is new. A rib comprises two axial walls and a contact face, the latter being intended to come into contact with the ground during running. A circumferential rib has two walls of circumferential overall direction, one axially on the inside and the other axially on the outside. It is possible for a rib not to be circumferentially continuous but to be grooved, notably in the case of a tire intended for winter use.

What is meant by being positioned in line with the rib is that the centre of gravity of the electronic device is axially on the outside of the axially insidewall of the rib and axially on the inside of the axially outside wall of the rib, with a 5 mm tolerance on the axial positioning.

Advantageously, the circumferential position of the electronic device is opposite the static out-of-balance of the tire, so that the static and dynamic balancing can be performed as economically as possible. Indeed the mass of certain present-day electronic devices are similar to that of the balancing weights used to correct imperfect distribution of mass, referred to as out-of-balance, on the volume of revolution that the tire represents, and that leads to imbalance. The electronic device can therefore be used as a balancing weight so as to reduce the remaining mass of balancing weights that needs to be added.

Installing the electronic device requires a fitting operation and it is therefore advantageous for at least one balancing weight to be positioned radially on the inside of the inner liner of the tire so as to meet the requirements of static and dynamic balancing, during that same operation, with a view to reducing the costs associated with that operation. This operation of adding a balancing weight is all the more attractive when the circumferential position of the static out-of-balance of the tire has already been determined for positioning the electronic device and therefore need not be determined again.

### BRIEF DESCRIPTION OF THE DRAWINGS

The features and other advantages of the invention will be understood better with the aid of FIGS. 1 to 4, said figures not being drawn to scale but in a simplified manner so as to make it easier to understand the invention.

FIG. 1 depicts a tire according to the prior art,

FIG. 2 illustrates the terms “inner edge” and “outer edge” of a tread,

FIGS. 3 to 4 depict two embodiments of the invention.

### DETAILED DESCRIPTION OF THE DRAWINGS

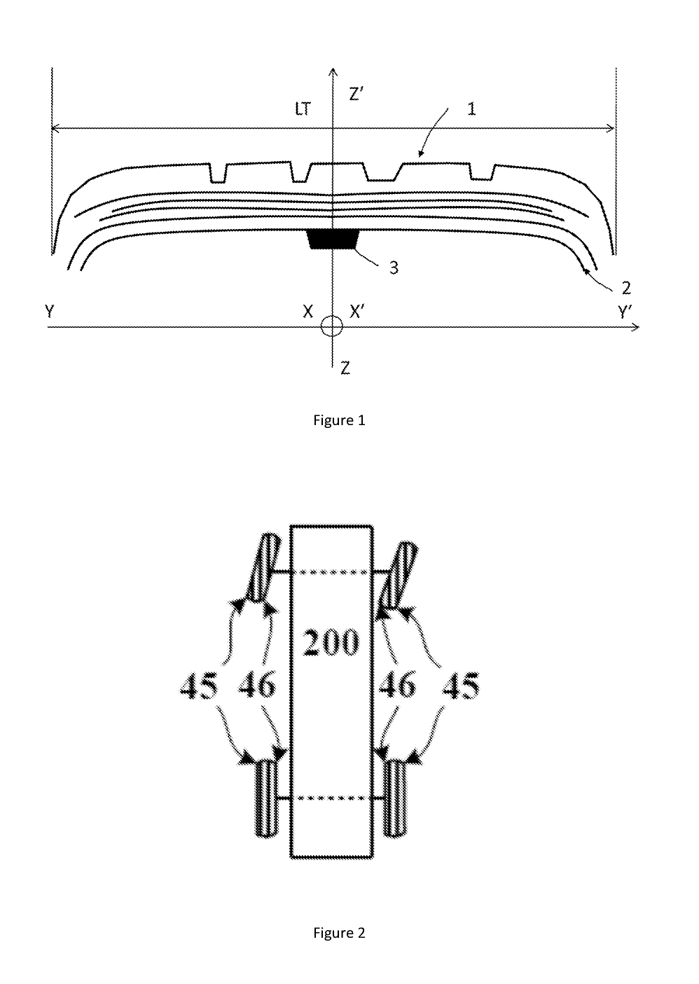

FIG. 1 depicts a tire viewed in meridian cross section provided with an electronic device 3 according to the prior art. The tire comprises a tread 1, an inner liner 2, radially on the inside of the tread and an electronic device 3, radially on the inside of the inner liner and the centre of gravity of which is in the equatorial plane, to within the positional accuracy.

FIG. 2 schematically depicts tires intended to be mounted on mounting rims of wheels of a vehicle 200 and having a predetermined direction of mounting on the vehicle. They comprise an outer axial edge 45 and an inner axial edge 46, the inner axial edge 46 being the edge intended to be mounted on the bodyshell side of the vehicle when the tire is mounted on the vehicle in the said predetermined direction of mounting, and the outer axial edge 45 being the opposite of that.

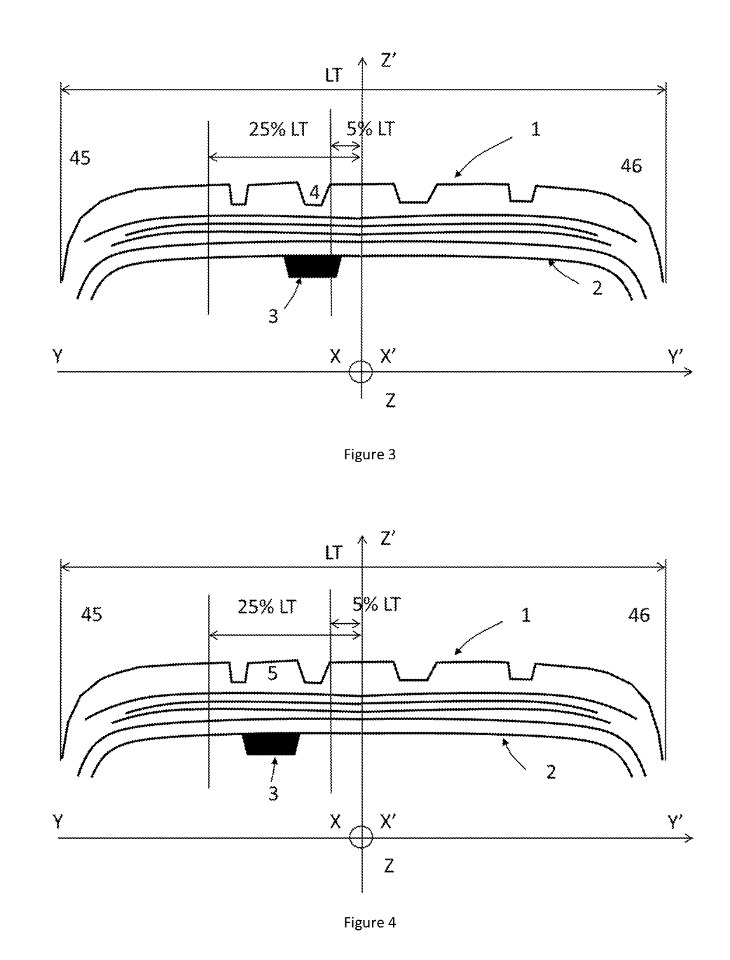

FIG. 3 shows a tire viewed in meridian section provided with an electronic device 3 according to the invention in which the centre of gravity of the electronic device 3 is situated on the side of the outboard axial edge 45 of the vehicle with respect to the equatorial plane and at a distance from the equatorial plane that is at least equal to 5% of the maximum axial width of the tire LT and at most equal to 25% of this width. In this figure, the centre of gravity of the electronic device 3 is situated radially in line with the circumferential groove 4 in the tread.

FIG. 4 shows a tire equipped with an electronic device 3 according to the invention and in which the centre of gravity of the electronic device 3 is situated in line with a rib 5 of the tread.

The inventors implemented the invention on an asymmetric tire of size 305/30ZR20 103Y, with a maximum axial width of 313 mm, tested with a camber angle of 2.5° so as to take account of the technical requirements of a vehicle for which it is specifically intended. The test consisted in running on a metal rolling road 8.5 m in circumference, at a set pressure of 3.2 bar and a set load of 587 daN. The tire was run at levels of increasing speed, lasting 20 minutes each, the speed increment being 10 km/h. The tires are classified according to the maximum speed achieved and the length of running at the last speed level achieved.

The tire without the electronic device reached the level of 370 km/h and ran at this speed for 11 minutes. As for the tire according to the prior art, namely equipped with the electronic device, a pressure sensor weighing 7 g, positioned according to the prior art and therefore installed in the tire in such a way that its centre of gravity is in the equatorial plane, to within the positioning tolerance of 1% of the maximum axial width, this tire achieved the speed level of 340 km/h and failed after running under these conditions for one minute. This result, when compared with that of the tire not fitted with the electronic device, demonstrates the drop in endurance performance at very high speed caused by the presence of the electronic device. This failure is connected with the 15° C. increase in crown temperature seen by numerical simulation in line with the sensor, this being at the same speed on the tire not equipped with an electronic device and on the tire equipped with the electronic device according to the prior art.

The inventors tested two embodiments of the invention. The first embodiment consisted in installing the electronic device at a distance from the equatorial plane of 16% of the maximum axial width, in line with a rib of the tread. In this case, the tire according to the invention achieved the speed level of 360 km/h and ran for 15 minutes at this level. This, when compared to the result of the tire equipped with the electronic device positioned in the equatorial plane, namely the maximum achieved level of 340 km/h, demonstrates the improvement in high-speed endurance of the tire equipped with the electronic device as described by the invention.

The second embodiment consisted in installing the electronic device at a distance from the equatorial plane of 7% of the maximum axial width, in line with a groove of the tread. In this case, the tire according to the invention achieved the speed level of 370 km/h and ran for 15 minutes at this level. The maximum crown temperature dropped by almost 15° C. This result, when compared to the result of the tire equipped with the electronic device positioned in the equatorial plane, namely the maximum achieved level of 340 km/h, shows the improvement in high-speed endurance of the tire equipped with the electronic device as described by the invention according to this second embodiment.

1. A tire with a maximum axial width LT, adapted to be mounted on a mounting rim, comprising:
two beads, adapted to come into contact with the mounting rim, a crown comprising a tread adapted to be in contact with the ground, two sidewalls connecting the crown to the beads,
the tread, asymmetric about the equatorial plane, delimiting two axial edges of the tread, one of which edges is adapted to be positioned on the outboard side of a vehicle on which the mounting rim is fixed,
an inner liner of the crown which is radially furthest on the inside of the crown,
an electronic device,
wherein the electronic device is installed in the tire under the crown, radially on the inside of the inner liner of the crown, on the side of the axial edge of the tread that is adapted to be positioned on the outboard side of the vehicle with respect to the equatorial plane.

2. The tire according to claim 1, wherein the electronic device comprises at least one measurement sensor making it possible to measure at least one parameter of the tire.

3. The tire according to claim 1, wherein the axial distance between the centre of gravity of the electronic device and the equatorial plane is at least equal to 5% of the maximum axial width of the tire LT.

4. The tire according to claim 1, wherein the axial distance between the centre of gravity of the electronic device and the equatorial plane is at most equal to 25% of the maximum axial width of the tire LT.

5. The tire according to claim 1, wherein the centre of gravity of the electronic device is situated radially in line with a circumferential groove in the tread.

6. The tire according to claim 1, wherein the centre of gravity of the electronic device is situated radially in line with a rib of the tread.

7. The tire according to claim 1, wherein the circumferential position of the electronic device is opposite the static out-of-balance of the tire.

8. The tire according to claim 1, wherein at least one balancing weight is positioned radially on the inside of the inner liner of the tire.
